(19) United States
(12) Patent Application Publication
(10) Pub. No.: US 2020/0095521 A1
(43) Pub. Date: Mar. 26, 2020

(54) Shelf Stable Formulations for Home, Institution and Industrial Uses

(71) Applicant: Inolex Investment Corporation, Wilmington, DE (US)

(72) Inventor: Rocco Burgo, Mullica Hill, NJ (US)

(73) Assignee: Inolex Investment Corporation, Wilmington, DE (US)

(21) Appl. No.: 16/576,461

(22) Filed: Sep. 19, 2019

Related U.S. Application Data
(60) Provisional application No. 62/733,943, filed on Sep. 20, 2018.

(51) Int. Cl. C11D 3/20; C11D 3/32

(52) U.S. Cl. CPC C11D 3/2058; C11D 3/32

(57) ABSTRACT

Included within the scope of the invention are methods of preparing a shelf-stable Formulation comprising mixing a solvent, at least one of a surfactant, a fabric conditioner, detersive agent (detergent), emulsifier, humectant, a colorant, a mechanical sunscreen, a fragrance, a chelator, an antioxidant, a UV absorbing compound, a particulate, a cationic emulsifier, a nonionic emulsifier, an anionic emulsifier, an antimicrobial, and a stabilizer selected from the group consisting of: a hydroxamic acid, or a salt and/or a complex thereof and a hydroxamic acid or a salt and/or a complex thereof and an alcohol, wherein the stabilizer is present in the Formulation in an amount of about 0.1% to about 3% by weight of the entire Formulation.

### CROSS REFERENCE TO RELATED APPLICATIONS

This application claims the benefit under 35 U.S.C. § 119(e) of U.S. Provisional Patent Application Ser. No. 62/733,943, filed Sep. 20, 2019, entitled, “Shelf Stable Formulations for Home, Institution and Industrial Uses,” the entire disclosure of which is incorporated herein by reference.

### BACKGROUND OF THE INVENTION

Numerous cleaning and surface treatment formulations are used every day in homes, institutions, and industry. Such formulations include cleaning products for, e.g., hard surfaces, soft furnishings, and textiles, conditioning agents, for example, for textiles and yarns, and surface treatments for, e.g., molds, metal surfaces, leathers, polymer surfaces and the like. Because such products are often maintained by the end user for long periods of time before being used, they often become spoiled as time passes, either by microbial proliferation or by chemical breakdown of the component materials. To extend the shelf life of such products various stabilizers and preservatives are used.

There is a need in the art for a shelf stable formulation that contains an effective stabilizer which is also non-toxic and non-irritating to humans and animals, and is effective at low dosages. Such formulation would have the advantage of achieving long term shelf stability while being economical and safe.

### BRIEF SUMMARY OF THE INVENTION

Included within the scope of the invention are methods of preparing a shelf-stable Formulation comprising mixing a solvent, at least one of a surfactant, a fabric conditioner, detersive agent (detergent), emulsifier, humectant, a colorant, a mechanical sunscreen, a fragrance, a chelator, an antioxidant, a UV absorbing compound, a particulate, a cationic emulsifier, a nonionic emulsifier, an anionic emulsifier, an antimicrobial, and a stabilizer selected from the group consisting of: a hydroxamic acid, or a salt and/or a complex thereof and a hydroxamic acid or a salt and/or a complex thereof and an alcohol, wherein the stabilizer is present in the Formulation in an amount of about 0.1% to about 3% by weight of the entire Formulation.

Also included are methods of improving the shelf stability of a Formulation that comprises at least one of a fabric conditioner, detersive agent (detergent), emulsifier, humectant, a colorant, a mechanical sunscreen, a fragrance, a chelator, an antioxidant, a UV absorbing compound, a particulate, a cationic emulsifier, a nonionic emulsifier, an anionic emulsifier, and antimicrobial, comprising adding to the Formulation stabilizer wherein the stabilizer is selected from the group consisting of: a hydroxamic acid, or a salt and/or a complex thereof and a hydroxamic acid or a salt and/or a complex thereof and an alcohol, wherein the stabilizer is present in the Formulation in an amount of about 0.1% to about 3% by weight of the entire Formulation.

In some embodiments, the Formulation is for use in home care, industrial care, or institutional care, and the Formulations, may be, for example, for application to textiles or hard surfaces.

### DETAILED DESCRIPTION OF THE INVENTION

As used herein the term “Formulation”, in plural or singular, unless modified by an adjective (e.g., “hard surface” or “degreaser”) shall refer generically to the shelf stable home, institutional and industrial compositions described herein, regardless of end application.

The term “textile formulation” as used herein includes any composition applied to a textile for the cleaning, conditioning, and/or treatment of a textile and/or fibers that are or can be made into a textile, and includes, without limitation, detergents, cleaners, shampoos, conditioners, softeners, leave-on compositions, rinse-off compositions, and the like.

The term “textile” includes woven and non-woven materials, furs, hides, leathers, fabrics, felts, tissues, rugs, carpets, foamed resins, fills, and the like.

The term “hard surface cleaner” includes any composition applied to a hard surface for the cleaning, conditioning, and/or treatment of indoor or outdoor hard surfaces, such as for example, cleaners, polishes, disinfectants, patinators, non-permanent coatings, waxes, and similar. Hard surfaces can include, for example, wood, plastic, rubber, steel, painted surfaces, linoleum, tile, stone, ceramics, earthenwares, concrete, polished concrete, macadam, glass, mirrored or reflective surfaces, fiberglass, metals, etc.

“Industrial formulations” as used herein include product used in industrial and manufacturing processes, such as, for example, mold release compositions, coatings, lubricants, residue removers, cleaners, etc.

The Formulations as described herein include a stabilizer that is one of a hydroxamic acid, or a salt and/or a complex thereof or a blend or mixture of a hydroxamic acid, or a salt and/or a complex thereof and an alcohol.

For use as or in the stabilizer of the invention, the alkylhydroxamic or hydroxamic acid may be present in its free (un-neutralized) or salt (neutralized) form, and it shall be understood that the terms “hydroxamic acid” and “alkylhydroxamic acid” include within the scope thereof the free acid form of the compounds as well as their salts and/or complexes thereof as well as materials which are precursors to such compounds, salts and complexes which upon addition react to form such compounds, salts and complexes, unless otherwise specifically noted.

The selected alkylhydroxamic acid(s) may have linear or branched carbon chain of from about two to about twenty-two carbon atoms, and preferably from about six to about twelve carbon atoms. The carbon chains may include double bonds, i.e., areas of unsaturation and may also have functionality depending on desired end use and properties. For example hydroxy groups may be beneficial side- or terminal-substituents on the chain leading to better water compatibility.

Suitable hydroxamic acids include alkylhydroxamic acids that include at least one alkyl group of a chain length of about two to about twenty-two carbon atoms, which may be branched or linear in structure, substituted or unsubstituted, and saturated or unsaturated. It may be preferred that the alkylhydroxamic acids contain alkyl groups of a chain length of about six to about twelve carbon atoms and most preferably linear chains of that length and/or having a linear terminal chain of eight carbon atoms and having a linear chain of ten carbon atoms. Such alkylhydroxamic acids may be used alone or in combination for varying effects and properties, and/or may be the result of use of precursors used as starting components in the Formulation.

In an embodiment, a suitable hydroxamic acid may have a formula as shown in Formula (I):

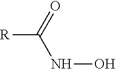

wherein R is a linear or branched, substituted or unsubstituted, carbon chain of about two to about twenty-two carbon atoms, which chain may be interrupted by one or more oxygen atoms, and may include saturated or unsaturated carbon bonds. Accordingly, R groups may include, for example, alkyl, alkyenyl, alkynyl, alkoxy, alkenoxy, alkynoxy and similar groups, are branched or linear, and which groups may be further functionalized using substituted groups, including hydroxy or other acceptable end groups for use and compatible with household, institutional and/or industrial applications.

Hydroxamic acids with functional groups that meet the criteria of being compatible with and/or are suggested for use in cleaning formulations are also within the scope of the invention. Such hydroxamic acids may also be synthesized from natural oils using lipase catalysis as well as other hydroxamic synthesis techniques known or to be developed in the art. Examples may include, without limitation, the hydroxamic acids disclosed in, e.g., U.S. Pat. No. 9,073,821 B2 and U.S. Pat. No. 6,207,679 B1; United States Patent Application Publication No. 2011/0178042 A1 and 2004/0106666 A1, the contents of each of which are incorporated herein by reference.

Specific examples of such alkylhydroxamic acids include, but are not limited to hexanohydroxamic acid, caprylohydroxamic acid, caprohydroxamic acid, laurohydroxamic acid and mixtures and combinations thereof, and most preferably is caprylohydroxamic acid.

It should be noted herein that precursors, such as hydroxy acids in combination with, for example, hydroxylamine hydrochloride or a similar compounds which can react within solution and/or in the formulation to form the various hydroxamic and alkylhydroxamic acids, salts and/or complexes thereof as are known in the art may also be used instead of a direct additive within the scope of the invention.

The stabilizers described herein also include an alcohol, such as, without limitation, an aromatic alcohol, a diol, and/or a vicinal diol. If a vicinal diol is selected, any vicinal diol(s) may be used, alone or in combination with another alcohol. “Vicinal diols” are materials that have hydroxyl groups which are bonded to atoms in the molecule which are next to each other, i.e., wherein two atoms each bearing a hydroxyl group are bonded to each other. Without limitation, vicinal diols useful in the compositions described herein include molecules derived from glycerin. Glycerin can be reacted with other molecules at its 1- or 3-position, leaving two vicinal hydroxyl groups. For example, glyceryl monoethers, such as ethylhexylglycerin [3-(2-ethylhexyloxy)propane-l ,2-diol], available commercially as SENSIVA®SC50 from Schulke & Mayer, are useful liquid vicinal diols having antimicrobial properties. Glyceryl monoesters such as glyceryl monolaurate, glyceryl monocaproate, or glyceryl monocapyrlate, the latter of which is commercially available as LEXGARD® GMCY from Inolex, Inc., Philadelphia, Pa., are also suitable vicinal diols.

Additional examples of these elements include, for example, glycols; such as caprylyl glycol, propylene glycol, butylene glycol, and hexylene glycol; 1,2-hexanediol, 1,2-pentanediol. 1,3-propanediol, 1,2-decanediol, 1,2-dodecanediol, pentylene glycol (1,5-pentanediol).

Other suitable options may include 1,3-propanediol; 2,3-butanediol; 1,6-butanediol; 1,3-butanediol; 2-methyl-1,3 propanediol; 2-methyl-2,4 pentanediol; and/or 2,2-dimethyl 1,3-propanediol.

The stabilizer includes hydroxamic acid(s) and the alcohol(s) in any ratio effective to provide stabilizing effects to the end Formulation. However, as a general and exemplary proposition, it may be preferred that the weight ratio of hydroxamic acid(s) to alcohol(s) is about 1 to about 2; about 1 to about 5; 1 to about 7.5; 1 to about 10; 1 to about 15; and 1 to about 30.

The stabilizer, if prepared in advance to the preparation of the final Formulation, may include other minor ingredients, such as colorants, fragrances, opacifiers, and an additional solvent.

In embodiments that have been found to be suitable, the stabilizer is, for example:
Caprylohydroxamic acid and glyceryl caprylate in a weight ratio of 10:75;
Caprylohydroxamic acid and ethylhexylglycerin in a weight ratio of 15:70;
Caprylohydroxamic acid and phenoxyethanol in a weight ratio of 15:30;
Caprylohydroxamic acid, glyceryl caprylate and methylpropanediol in a weight ratio of 10:75:15;
Caprylohydroxamic acid, ethylhexylglycerin and methylpropanediol in a weight ratio of 15:30:55; and
Caprylohydroxamic acid, phenoxyethanol, and methylpropanediol in a weight ratio of 15:70:7.5:7.5.

The stabilizers described herein are present in the Formulations in an effective amount to maintain the formulation stability of the Formulation over a period of time, for example, 6 months, 12 months, 24 months, 48 months, and/or 65 months. In general such amount(s) may be, for example, about 0.1 to about 10%, about 0.3 to about 7%, about 0.5% to about 5%, about 1% to about 5%, each by weight of the total Formulation.

As prepared, the stabilizers-containing Formulations described herein may include one or more of a myriad of ingredients under in home, institutional and industrial products, including cleansers, surface treatments, etc.

For example, the Formulations described herein may also include a surfactant or surfactant system. Such system includes one or more surfactants as in known or to be developed in the art. Surfactants that may be used include anionic surfactants, amphoteric, and/or zwitterionic surfactants, a non-ionic surfactants, and/or mixtures of the same. Anionic surfactants may include, for example, those containing one or more sulfate, sulfonate, phosphate, or carboxylate functional group, surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. If selected, these surfactants may be used in the form of water-soluble salts and the salt-forming cation usually is selected from sodium, potassium, ammonium, magnesium and mono-, di- or tri-C₂-C₃ alkanolammonium.

Without limitation, more specific examples may include alkyl sulfates, such as ammonium lauryl sulfate, sodium lauryl sulfate, sodium dodecyl sulfate (SLS, or SDS), sodium nonylphenol ethoxylate sulfate and alkyl-ether sulfates such as sodium laureth sulfate, (sodium lauryl ether sulfate or SLES), sodium myreth sulfate; alkyl alkoxy sulfates; alkyl ethoxy sulfates; alkyl benzene sulfonate; paraffin sulfonate, dioctyl sodium sulfosuccinate, alkyl-aryl ether phosphates, alkyl ether phosphates; carboxylates, including without limitation, alkyl carboxylates (soaps), such as sodium stearate, sodium lauroyl sarcosinate, and carboxylate-based fluorosurfactants such as perfluorooctanesulfonate (PFOS), perfluorobutanesulfoante; ph-dependent primary, secondary, or tertiary amines, e.g., octenidine dihyudrochloride; permanently charged quaternary ammonium salts, such as, for example, cetrimonium bromide, cetylpyridinium chloride, benzalkonium chloride, benzethonium chloride, dimethyl dioctadecylammonium chloride, dioctadecyl ammonium bromide; water-soluble salts of C₈-C₁₈ alkyl or hydroxyalkyl, sulfate and/or ether sulfate having counterions of alkali metal cation, ammonium, substituted ammonium, or sodium, including, for example, primary, branched chain and random alkyl sulfates (AS); C₈-C₁₈ secondary (2,3) alkyl sulfates; C₈-C₁₈ alkyl alkoxy sulfates (AExS) wherein preferably x is from 1-30 in which the alkoxy group could be selected from ethoxy, propoxy, butoxy or even higher alkoxy groups and mixtures thereof.

Zwitterionic (amphoteric) surfactants may include, for example, sultaines, hydroxysultaine; betaines, such as cocamidopropyl betaine; phosphatidylserine, phosphatidylethanolamine, phosphatidylcholine, sphingomyelins, amine oxides, for example, alkyl dimethyl amine oxide, etc.

Exemplary nonionic surfactants that can be included are ethoxylates, fatty alcohol ethoxylates, alkylphenol ethoxylates, fatty acid ethoxylates, special ethoxylated fatty esters and oils, terminally blocked ethoxylates, fatty acid esters of polyhydroxy compounds, fatty acid esters of glycerol and sorbitol, sulfoxides, fatty acid esters of sucrose, alkyl polyglucosides, amine or phosphine oxides and mixtures of the same. Specific surfactants can be selected from, for example, ethoxylated amines and/or fatty acid amides, narrow-range ethoxylates, octaethylene glycol monododecyl ether, pentaethylene glycol monododecyl ether, nonoxynols, Triton X-100, polyethoxylated tallow amine, cocamide monoethanolamine, cocamide diethanolamine, poloxamers, glycerol monostearate, glycerol monolaurate, sorbitan monolaurate, sorbitan monostearate, sorbitan tristearate, Tween 20, Tween 40, Tween 60, Tween 80, decyl glucoside, dauryl glucoside, octyl glucoside, lauryldimethylamine oxide, dimethyl sulfoxide, phosphine oxide and mixtures of the same.

The precise composition of the surfactant system selected and/or the amount of the system will depend on various factors know to a person of skill in the art, for example, contemplated end use, co-ingredients, market target, etc. In an embodiment, the surfactant system may be a cationic/non-ionic blend, such as the commercially available STEPSOL DG.

Such surfactants systems are well known in the art. As an example, for use in a detergent for application to textiles the surfactant system may include anionic surfactant(s)in an amount of about 10% by weight to about 50% by weight and the amphoteric/zwitterionic surfactant(s) in an amount of about 90% to about 50%, by weight of the weight of the system.

The surfactant or surfactant system may be present in the Formulation in any suitable amount. By way of an example, in a detergent for application to textiles the surfactant system may be present in an amount of about 1% to about 70%, about 5% to about 60%, about 15% to about 55%, about 20% to about 40% by weight of the total Formulation. In some embodiments, it may be preferred that the surfactant or surfactant system is present in an amount of about 1% to about 3%, about 5% to about 10%, about 7% to about 15%, about 10% to about 20%.

Any solvent or carrier may be included in the Formulation. Such solvents may include water, oils, alcohols, such as isopropanol; naphtha, d-limonene, kerosene, propylene glycol, mineral spirits, methyl soyate, chlorinated solvents, and mixtures of the same.

In specialized formulations, such as textile formulations, it is expected that various ingredients tailored to the end use will be included. For example, in the case of textile formulations, fabric conditioners, optical brighteners, bleaches, and the like may be included. Other ingredients in any type of Formulation may include, for example, emulsifiers, builders, thickeners, degreasers, flavorants, fragrances, UV absorbing compounds, reflectant compounds, film formers, colorants, pearlescents, opacifiers, clays, waxes, gums, fats, oils, proteins, antioxidants, optical brighteners, ammonia-containing compounds, formaldehyde, defoamers, enzymes, hydrotropes, lanolins, rheological modifiers, metal passivation agents, polymers, lubricants, scrub agents, pH regulators, polishing/burnishing additives, dyes, disintegrants, wetting agents, detersive agents (detergent), emulsifier, humectant, a mechanical sunscreen, a fragrance, a chealtor, an antioxidant, a UV absorbing compound, a particulate, a cationic emulsifier, a nonionic emulsifier, an anionic emulsifier, and/antimicrobial and the like.

The following examples are provide to demonstrate the formulation so of the invention and are illustrative, not limiting to the scope of the invention.

### EXAMPLES

In all the following Examples, the Stabilizer of the Invention was a blend of Caprylyl glycol, glycerol, and caprylhydroxamic acid in a weight ratio of 71:14:15

### Example 1—Daily Shower or Tile/Counter Cleaner

The daily shower cleaner can be used every day without scrubbing, rinsing or wiping to prevent soap-scum buildup on conventional shower room surfaces. The cleaner is prepared as follows: The formulation is provided in Table 1. Water is added first to a vessel and blended with the foaming and cleansing agent. Under agitation, the emulsifier is added and mixing is carried out until the mixture is homogenous. The solvent and the chelating agent is added. pH is adjusted to 5.0-5.5 with citric acid as needed.

TABLE 1

| Ingredient | % by weight |
|---|---|
| Deionized water | 94.5 |
| Lauramine oxide | 3.0 |
| Lauryl alcohol ethoxylate, POE-7 | 1.0 |
| Propylene glycol n butly ether (solvent) | 1.0 |
| Stabilizer of the Invention | 0.5 |
| Citric acid (50% soln) | qs |
| Total | 100 |

### Example 2—Carpet Cleaner

This carpet cleaner is for use in a steam extract device and generates a moderate amount of foam. Residue left on the carpet dries to a crisp friable powder. The cleaner is prepared as follows: The formulation is provided in Table 2. Ingredients are added in the order they are listed under continuous stirring.

TABLE 2

| Ingredient | % by weight |
|---|---|
| Deionized water | 72.0 |
| tetrapotassioum pyrophosphate (“TKPP”) | 5.0 |
| Methoxyisopropanol | 4.0 |
| Sodium caprylyl sulfonate (anionic surfactant) | 16.0 |
| Stabilizer of the Invention | 3.0 |
| TOTAL | 100.0 |

### Example 3—Hard Surface and Floor Cleaner Concentrate

This formulation can be sued to clean floors and other hard surfaces manually or in auto mated scrub machines. It produces moderate, fast-breaking foam. The cleaner concentrate is prepared as follows: The formulation is provided in Table 3. Ingredients are added in the order listed in the table and mixing is accrued out until the mixture is homogenous. The cleaner concentrate can be used at a dilution of 1 to 4 ounces per gallon.

TABLE 3

| Ingredient | % by weight |
|---|---|
| TKPP | 20.0 |
| Cocamide DEA | 7.3 |
| Sodium xylene sulphonate | 2.0 |
| Stabilizer of the Invention | 0.7 |
| Water | 70.0 |
| TOTAL | 100.00 |

### Example 4—Fabric Softener/Conditioner

This is a 20% solids ultra fabric softener that is for use in the rinse cycle of the wash load. The fabric softener is prepared as follows: The formulation is provided in Table 4. A vessel is charged with 55° C. water. Slowly, about 65% to about 755 of the overall quantity of the methyl bis[ethyl(tallowate)]-2-hydroxyelthy ammonium methyl sulfate (previously heated to 50° C.) is added to the water while mixing is applied. Mixing is continued for 30 minute to disperse the methyl bis[ethyl(tallowate)]-2-hydroxyelthy ammonium methyl sulfate. The mixture begins to appear like a thick cream. ⅓-½ of the salt solution is added to reduce the viscosity of the dispersion.

The remaining methyl bis[ethyl(tallowate)]-2-hydroxyelthyammonium methyl sulfate is added. Mixing is continued for an additional 30 minutes. The remaining salt solution is added to achieve desired viscosity. Preservative and any other additives (fragrance, optical brightener, etc.) are added. Additional salt may be necessary to reach desired viscosity.

TABLE 4

| Ingredient | % by weight |
|---|---|
| Methyl bis[ethyl(tallowate)] -2- hydroxyelthy ammonium | 22.22 |
| methyl sulfate (cationic surfactant) | |
| Calcium chloride (33% soln) | 1.0 |
| Stabilizer of the Invention | 0.6 |
| Water | 76.18 |
| TOTAL | 100.0 |

This softener provides excellent and static control while maintaining the rewet products of the fabric.

### Example 5—Dishwashing Detergent

This dishwashing detergent is for consumer use in manual dishwashing. It provides good performance in cold water, including good flash foaming, grease cutting and detergency.

The dishwashing detergent is prepared as follows: The formulation is provided in Table 5. Ingredients are added in the order they are listed under continuous stirring. After each addition, mix until homogeneous. Adjust pH with citric acid, if necessary. Use sodium chloride to increase viscosity, if needed.

TABLE 5

| Ingredient | % by weight |
|---|---|
| Deionized water | Q.S. to 100% |
| Sodium lauryl sulphate (anionic surfactant) | 55.17 |
| Lauramine oxide (amphoteric surfactant) | 21.05 |
| Stabilizer of the Invention | 0.05 |
| TOTAL | 100.0 |

### Example 6—Dishwashing Powder

This dishwashing powder is for use in industrial machines and provides good performance at low temperatures, low foam, defoaming of food soils with no spotting etching or streaking of glassware.

The formulation is provided in Table 6. To prepare, a blender is charged with the sodium carbonate add surfactant and mix for one minute. Add remaining ingredients in order under moderate agitation until thoroughly mixed.

TABLE 6

| Ingredient | % by weight |
|---|---|
| Sodium tripolyphosphate, dense | 40.0 |
| Alkoxylated isopropanolamide (nonionic surfactant) | 3.0 |
| Sodium silicate | 27.0 |
| Sodium dichloroisocyanurate dihydrate | 2.0 |
| Sodium carbonate | 25.0 |
| Stabilizer of the Invention | 3.0 |
| TOTAL | 100.00 |

The resulting dishwashing powder provides good performance at low temperatures and low foam, with no streaking of glassware.

### Example 7—Regular Fluid Fabric Softener

This fluid fabric softener can be used in the rinse cycle of the textile wash to provide softening and static control and to maintain the rewetting properties of the fabric. The formulation is provided in Table 7. To prepare add the tap water, the dye and the stabilizer into a reactor vessel. Separately, melt and mix the dipalmityoylethylhydroxyethylammonium methosulfate. Apply stirring to the reactor vessel, then, while stirring add it to reactor. Stir until the blend is homogeneous and has a white, shiny, and smooth appearance. Cool to 35° C. under agitation. Add the calcium chloride solution to the reactor, which will cause the blend become fluid instantaneously. Continue cooling to 30° C. Add the fragrance.

TABLE 7

| Ingredient | % by weight |
|---|---|
| Tap water | 81.9 |
| Dipalmitoylyethyl hydroxyethylmonium | 16.9 |
| methosulfate (textile conditioner) | |
| Calcium Chloride (25% aqueous) | 0.3 |
| Stabilizer | 0.3 |
| Fragrance | 0.6 |
| TOTAL | 100 |

Overall, the appearance at 25° C. is of an opaque liquid, the pH, as is 2.8-3.0 and the viscosity is about 120 mPa·s (Brookfield RVT M4/V100).

### Example 8—Industrial Tile Cleaner

This cleaner can be used in a concentrated form on heavily-soiled tile floors or, in diluted form, for daily cleaning of floors.

The ingredients are provided in Table 8. To prepare, mix the ingredients at room temperature in the order they are listed.

TABLE 8

| Ingredients | % by weight |
|---|---|
| Deionized water | 87.0 |
| Linear alkylbenzene sulphonic acid (Anionic | 4.0 |
| surfactant/degreaser) | |
| Linear alcohol (C11) ethoxylate, POE-7 | 3.5 |
| (High active non-ionic surfactant/degreaser) | |
| Stabilizer of the Invention | 1.0 |
| Hydroxy acetic acid (70%) | 3.0 |
| Hydrochloric acid (37%) | 1.5 |
| TOTAL | 100.0 |

Once mixed, the formulation is a clear opalescent liquid with a pH of about <1, and a viscosity (25° C., Brookfield, spindle 1, 30 rpm) of about 55 cps.

One may use the cleaner for occasional heavy cleaning on a very soiled floor by pouring concentrate directly on a pre-wetted floor. Spread with mop and leave for ten minutes. Scrub, if desired, rinse with clean water and dry with mop or cloth. For daily cleaning, prepare a highly dilute formulation (for example, 1 part original formulation to 32 parts water), apply to floor, scrub and rinse. Allow to air dry.

### Example 9—Wax Stripper

This formulation can be used manually or with automated scrubbing machines. It is low-foaming with rinseability and pickup.

The ingredients and their amounts for the wax stripper are shown in Table 9. To prepare the stripper, charge reactors vessel with water and add sodium metasilicate under agitation. Continue agitation until sodium metasilicate is dissolved. While maintaining agitation, add the remaining ingredients in the order listed in the Table.

TABLE 9

| Ingredients | % by weight |
|---|---|
| Water | 60.0 |
| sodium metasilicate, anhydrous | 0.4 |
| Stabilizer of the Invention | 0.7 |
| Anionic surfactant (alkyether phosphate) | 4.0 |
| Sodium hydroxide, 50% solution | 1.6 |
| TKPP (tetrapotassium pyrophosphate), 60% | 33.3 |
| TOTAL | 100.00 |

When finished the stripper is a clear liquid at room temperature. Can be used neat or diluted by mixing 1 to 5 ounces in a gallon of water.

### Example 10—Glass Cleaner Concentrate

A glass cleaner concentrate is prepared that can be used in dilute form (preferably 1 part to 20 parts water) in households, institutions, offices, etc. It may also be used in vehicles as a windshield wiper fluid. The cleaner will not freeze at 0° C.

The ingredients and their amounts are shown in Table 10.

| Ingredients | % by weight |
|---|---|
| Deionized water | 96.38 |
| Lauramine oxide (amphoteric oxide) | 0.7 |
| Sodium caprylyl sulphonate (hydrotropes) | 1.0 |
| Stabilizer of the Invention | 1.0 |
| TOTAL | 100.0 |

To prepare, charge a vessel with the water, then add the remaining ingredients while mixing until homogenous. The final formulation is a water thin clear liquid.

### Example 11—Graffiti Remover

This remover is able to remove graffiti from most surfaces. The ingredients and their amounts are shown in Table 11.

| Ingredients | % by weight |
|---|---|
| Methyl soyate and ethyl lactate blend | 80.0 |
| (Solvent) | |
| Lauryl alcohol ethoxylate, POE 7(Nonionic | 10.0 |
| surfactant) | |
| Stabilizer of the Invention | 3.0 |
| Citrus Burst ® 7 available from Florida | 5.0 |
| Chemical, Winterhaven, Florida (proprietary | |
| mixture of d-Limonene and Carboxylate | |
| Esters | |
| Cellulose ether film former | 2.0 |
| TOTAL | 100.0 |

To prepare, combine ingredients in the order they appear and mix until the mixture is homogenous. This remover may be packaged in a PET or fluorinated HDPE container.

### Example 12—Household General Purpose Degreaser

This degreaser dissolves grease and grime from most surfaces. It is suitable for cleaning most household items such as grills, outdoor furniture, stovetops, ovens, engines and tools.

The ingredients and their amounts are shown in Table 12.

| Ingredients | % by weight |
|---|---|
| Linear alcohol (C9-11) ethoxylate, POE-6 | 1.0 |
| (emulsifier) | |
| Sodium dodecylbenzene sulfonate (Anionic | 5.0 |
| surfactant) | |
| Sodium caprylyl sulfonate | 8.0 |
| N, N, dimethyl 9-decenmide (solvent & | 0.3 |
| surfactant) | |
| Stabilizer of the Invention | 0.5 |
| Deionized water | 83.2 |
| Sodium citrate (builder) | 0.3 |
| Dye | Q.S. to 100% |
| TOTAL | 100.0 |

To prepare, charge a vessel with the deionized water and under agitation blend in each ingredient separately in the order listed. Once dye is added, mix until homogenous.

The resulting degreaser can be used throughout the household by applying to surface, e.g., via a spray device, and wiping the surface clean. Rinsing is not required.

### Example 13—Wood Restorer for Finished and Painted Wood

This restorer aids in the restoration of many worn, aged finished wood surfaces such as floors and furniture. The formulation works to soften a surface's top layer of gloss coating in 1 to 2 minutes dwell time, providing deep cleaning of embedded soil. This also helps to fill in damaged and worn areas when spread around and left to dry. This formulation works on industrial or oil-based painted surfaces, or finished wood surfaces.

To prepare, mix 6 parts (by weight) of STEPOSOL® CITRl-MET, 93 part of soft water and 1 part Stabilizer of the Invention. Mix until homogenous.

To use, apply generously across the surface, including less worn areas. Allow to dwell 1 to 2 minutes, then wipe the entire surface to deep clean. For best restored finish, repeat application and 1 to 2 minute dwell time. Wipe gently with non-absorbent gloved hand with even strokes. Leave the surface wet to dry on its own for 10-60 minutes.

### Example 14—All Purpose Degreaser 1101

This neutral dilutable degreaser is suitable for general indoor household degreasing chores for kitchen surfaces such as countertops, exhaust vents and appliances. The ingredients and amounts are set forth in Table 13.

| Ingredients | % by weight |
|---|---|
| Phase 1: | |
| Deionized water | 84.0 |
| Phase 2: | |
| Lauryl alcohol ethoxylate, POE-7 (nonionic surfactant) | 1.0 |
| Sodium lauryl sulfate (anionic surfactant) | 2.0 |
| Butyl Carbitol | 4.0 |
| Propylene Glycol n-Butyl Ether | 4.0 |
| Stabilizer of the Invention | 2.0 |
| Phase 3: | |
| Sodium Citrate | 4.0 |
| [S,S]-Ethylenediaminedisuccinic | |
| TOTAL | 100.0 |

To prepare, charge a vessel with the water. Under good agitation, slowly blend in the Phase 2 ingredients. Once the mixture is clear, add the Phase 3 ingredients and mix until homogenous. The formulation may be used undiluted or diluted. To clean a surface, saturate sponge or cloth and wipe surface clean.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of preparing a shelf-stable Formulation comprising mixing
a solvent,
at least one of a surfactant, a fabric conditioner, detersive agent (detergent), emulsifier, humectant, a colorant, a mechanical sunscreen, a fragrance, a chealtor, an antioxidant, a UV absorbing compound, a particulate, a cationic emulsifier, a nonionic emulsifier, an anionic emulsifier, and antimicrobial and
a stabilizer selected from the group consisting of: a hydroxamic acid, or a salt and/or a complex thereof and a hydroxamic acid or a salt and/or a complex thereof and an alcohol, wherein the stabilizer is present in the Formulation in an amount of about 0.1% to about 3% by weight of the entire Formulation.

2. A method of improving the shelf stability of a Formulation that comprises at least one of a fabric conditioner, detersive agent (detergent), emulsifier, humectant, a colorant, a mechanical sunscreen, a fragrance, a chealtor, an antioxidant, a UV absorbing compound, a particulate, a cationic emulsifier, a nonionic emulsifier, an anionic emulsifier, and antimicrobial, comprising adding to the Formulation stabilizer wherein the stabilizer is selected from the group consisting of: a hydroxamic acid, or a salt and/or a complex thereof and a hydroxamic acid or a salt and/or a complex thereof and an alcohol, wherein the stabilizer is present in the Formulation in an amount of about 0.1% to about 3% by weight of the entire Formulation.

3. The method of claim 1, wherein the stabilizer is present in the Formulation in an amount of about 0.5% to about 1.5% by weight of the entire Formulation.

4. The method of claim 1, wherein the stabilizer is present in the Formulation in an amount of about 0.7% to about 2% by weight of the entire Formulation.

5. The method of claim 1, wherein the alcohol is a diol.

6. The method of claim 1, wherein the alcohol is a vicinal diol.

7. The method of claim 1, wherein the alcohol is aromatic.

8. The method of claim 1, wherein the hydroxamic acid, or a salt and/or a complex thereof is an alkylhydroxamic acid, or a salt and/or a complex thereof.

9. The method of claim 1, wherein the Formulation is a textile formulation and further comprises at least one of a textile conditioner, a detersive agent, an enzyme, and a surfactant.

10. The method of claim 1, wherein the Formulation is a hard surface formulation and further comprises at least one of a detersive agent, a surfactant, a degreaser, a defoamer, a wax and an oil.

11. The method of claim 1, wherein the Formulation is an industrial formulation and further comprises at least one of a degreaser, a surfactant, and a defoamer.
